(19) United States
(12) Patent Application Publication
(10) Pub. No.: US 2026/0358514 A1
(43) Pub. Date: Nov. 12, 2026

(54) Radioluminescent Films, Systems and Uses Thereof

(71) Applicants: Enlipsium Pte. Ltd., Singapore (SG); Singapore Health Services Pte Ltd, Singapore (SG)

(72) Inventors: Hong Qi Tan, Singapore (SG); Wei Yang Calvin Koh, Singapore (SG); Kah Seng Lew, Singapore (SG); Louisa Rui Lin Ting, Singapore (SG)

(73) Assignees: Enlipsium Pte. Ltd., Singapore (SG); Singapore Health Services Pte Ltd, Singapore (SG)

(21) Appl. No.: 19/135,586

(22) PCT Filed: Dec. 6, 2023
(86) PCT No.: PCT/SG2023/050813

§ 371 Date: Jun. 4, 2025

(30) Foreign Application Priority Data
Dec. 6, 2022 (SG) 10202260351W

(51) Int. Cl. G01T 1/202

(52) U.S. Cl. CPC G01T 1/2023

(57) ABSTRACT

The disclosure concerns radioluminescent films, systems and their uses thereof. The radioluminescent system comprises an imaging chamber comprising a camera and/or photodetector housed within the imaging chamber; and a control system operable to activate the camera and/or photodetector; wherein a radioluminescent film configured to exhibit persistent radio-luminescence upon excitation by an ionizing radiation is positionable within the imaging chamber for quantifying and/or spatially mapping the persistent radio-luminescence of the radioluminescent film by the camera and/or photodetector; wherein the radioluminescent film comprises a plurality of scintillator crystals dispersed on a surface of a polymer layer or within the polymer layer.

### TECHNICAL FIELD

The present invention relates, in general terms, to radioluminescent films, systems and their uses thereof.

### BACKGROUND

In radiation oncology, pre-treatment patient specific quality assurance (PSQA) is an integral part of any radiotherapy workflow and is required before each patient's treatment to ensure maximal agreement between the planned and delivered doses to the treatment site. Dose accuracy is important to ensure tumour local control and reduce the incidence of radiation toxicity. This is especially important in hypofractionated and highly conformal treatment such as intensity modulated radiotherapy (IMRT) stereotactic body radiotherapy (SBRT) or stereotactic radiosurgery (SRS). Pre-treatment PSQA is usually performed at night after last patient's treatment and the actual clinical treatment can only happen if the PSQA is a “pass”.

Even though pre-treatment PSQA is recognized as an integral part of the radiotherapy workflow, there is currently no consensus on the best commercial tool to be used for conducting PSQA. The measurement tools used in clinic ranged from Gafchromic films to 2D ion chamber or diode arrays. Gafchromic films have sub-millimeter resolution which is ideal for SRS PSQA, but is cumbersome to use. It requires at least 24 hours for the film to develop before the dose readout can be obtained, and this translates to an additional day delay for the patient's treatment (and provided the PSQA “passes”). Furthermore, Gafchromic film is single-use and have to be disposed after a single measurement for each patient; this translates to a higher costs incurred for the hospital and the patient. On the other hand, 2D ion chamber and diode arrays provide near real-time dose readout and is re-useable. The disadvantage is that the best resolution in this measurement tools in the current market is about 2.4 mm, which is not sufficient for small field treatment such as in brain SRS or Lung SBRT. The resolution is limited by the packing density of the ion chambers and diodes as well as the speed of the electronics signal read-out of the large number of detectors. Hence, there does not currently exists a commercial tool which offer both the advantages of convenience and high resolution detectors for small field conformal treatment.

It would be desirable to overcome or ameliorate at least one of the above-described problems.

### SUMMARY

The present disclosure provides a radioluminescent system, comprising:
a) an imaging chamber comprising a camera and/or photodetector housed within the imaging chamber; and
b) a control system operable to activate the camera and/or photodetector;
wherein a radioluminescent film configured to exhibit persistent radio-luminescence upon excitation by an ionizing radiation is positionable within the imaging chamber for quantifying and/or spatially mapping the persistent radio-luminescence of the radioluminescent film by the camera and/or photodetector;
wherein the radioluminescent film comprises a plurality of scintillator crystals dispersed on a surface of a polymer layer or within the polymer layer.

In some embodiments, the plurality of scintillator crystals is a plurality of perovskite-based quantum dots or rare earth metal based scintillators.

In some embodiments, the perovskite-based quantum dots is CsPbXₐY₃₋ₐ or the rare metal based scintillator is Na(Q_{b}R_{1-b})F₄, wherein X and Y are independently selected from Cl, Br, and I; a is a number selected from 0 to 3; Q and R are independently rare earth metals and b is a number which is more than 0 and less than 1.

In some embodiments, the plurality of scintillator crystals is about 1% w/w to about 30% w/w relative to the polymer layer.

In some embodiments, the polymer layer is flexible.

In some embodiments, the polymer is PDMS.

In some embodiments, the radioluminescent film is excitable by an ionising radiation of up to about 20 Gy.

In some embodiments, the radioluminescent film is characterised by a resolution of about 0.03 mm/pixel to about 0.1 mm/pixel.

In some embodiments, the camera and/or photodetector is adjustable via a displacement means, the displacement means configured to allow movement along any axis of the Cartesian axis and tilting along a longitudinal axis of the imaging chamber.

In some embodiments, the imaging chamber further comprises a heating plate.

In some embodiments, the radioluminescent film is configured to lose its persistent radio-luminescence after about 5 min upon contact with heat from the heating plate.

In some embodiments, the radioluminescent film is re-usable for at least 10 cycles.

In some embodiments, the radioluminescent film is characterised by a 2D dose resolution of less than 2 mm.

In some embodiments, the radioluminescent system is responsive to a radiation dose rate of less than about 50 nGy_{airS}⁻¹.

In some embodiments, the radioluminescent system is configured to quantify and/or spatially map the persistent radio-luminescence of the radioluminescent film in less than about 10 min.

The present invention provides a method of performing pre-treatment patient-specific quality assurance (PSQA) by using the radioluminescent system as disclosed herein.

### BRIEF DESCRIPTION OF THE DRAWINGS

Embodiments of the present invention will now be described, by way of non-limiting example, with reference to the drawings in which:

FIG. 1 shows a schematic and a picture of the system for measuring radioluminescence from a radioluminescent film.

FIG. 2 shows plots of the luminescence intensity against time post-irradiation for a sample with (left) 10% or (right) 5% doping with different amount of radiation doses.

FIG. 3 shows the total luminescence intensity (given by the area under the curve of FIG. 2) of the two film samples under different dose rate. The linear increase in luminescence intensity under different dose verifies that the sample exhibit radio-luminescence after absorbing megavoltage x-rays.

FIG. 4 shows an imaging chamber of the present disclosure.

FIG. 5 shows a see through view of the instrument chamber of an imaging chamber.

FIG. 6 shows a perspective view of the instrument chamber.

FIG. 7 shows a calibration plot of dose against pixel values.

FIG. 8 shows a plot of dose measurement accuracy.

FIG. 9 shows plots of the luminescence intensity against time post-irradiation for samples irradiated with a radiation dose of 5 Gy for various durations.

### DETAILED DESCRIPTION

The present disclosure is predicated on resolving the trade-off problem by using a radioluminescent film (for example, PDMS doped with rare earth metal-based nanoscintillators). The radioluminescent film fluoresce after x-ray irradiation and exhibit persistent radio-luminescence post-irradiation. Since the dosimetry is based on luminescence rather than chemical changes such as in Gafchromic film, its dose readout can be measured directly after irradiation by capturing all the afterglow fluorescence signal through heating of the film. The luminescence may persist for at least 3 mins. The radioluminescent film is re-useable about 5 min after the luminescence is expended through heating. Moreover, since the disclosure is based on film rather than diodes or ion chambers, it is capable of high resolution not limited by the packing density of the diode/ion chambers. Lastly, the film's mechanical flexibility allows innovative design and conforming to body's contour when used for in-vivo dosimetry.

The present disclosure provides a radioluminescent system, comprising:
a) an imaging chamber comprising a camera and/or photodetector housed within the imaging chamber; and
b) a control system operable to activate the camera and/or photodetector;
wherein a radioluminescent film configured to exhibit persistent radio-luminescence upon excitation by an ionizing radiation is positionable within the imaging chamber for quantifying and/or spatially mapping the persistent radio-luminescence of the radioluminescent film by the camera and/or photodetector;
wherein the radioluminescent film comprises a plurality of scintillator crystals dispersed on a surface of a polymer layer or within the polymer layer.

The radioluminescent system may provide high resolution spatial dose mapping of radioluminescent films and is a re-useable tool for performing patient specific quality assurance. The radioluminescent system allows for at least sub-millimetre two-dimensional dose resolution, which is only further limited by camera pixel resolution. Dose read-out may be directly obtained after irradiation. In this regard, the system is highly accurate as only regions of the radioluminescent film which coincides with the dosed site of a patient will exhibit persistent radio-luminescence. Depending on the intensity of the persistent radio-luminescence, the dosage may be in turn be quantified as these parameters are linearly co-related. An image of the illuminated radioluminescent film may also be captured by a camera. The radioluminescent film can be used multiple times before degradation. When the radioluminescent film is degraded and disposed, cost is kept to a minimum as the radioluminescent film can be cost effectively produced with minimal manufacturing steps. The radioluminescent film can be made from a flexible material which allows conformity to patient's body contour.

Further, a uniform dispersion of micron- to nano-sized scintillator crystals of the radioluminescent film may improve the resolution of the dosimeter (to about micrometer level resolution). Emission of scintillator crystals can be read out quickly after irradiation to allow for on-site, on-demand determination of radiation dose profile.

Current commercial solution such as Gafchromic film offers sub-millimetre resolution dose map but is single-use and typically requires one day for development before reliable dose readout can be performed. Gafchromic film is also not environmentally friendly. Ion/diode arrays are re-useable and offer real-time dose readout, but currently has a resolution in excess of 2 mm. The limited spatial resolution limits its ability to provide proper quality assurance to a small targeted area. Thermoluminescent detector has no spatial resolution, provides point dose measurement and has a dose accuracy of about 3-5%.

As used herein, “device” refers to a thing or entity made or adapted for a particular purpose, such as a piece of mechanical or electronic equipment. The device can be manually operated, or can computer implemented with instructions from a software.

As used herein, “system” refers to one or more devices configured with or interacting with each other based on a set of rules. The set of rules can be provided by a software and/or process protocols. In this sense, a system is a group of interacting or interrelated elements that act according to a set of rules to form a unified whole. A system, surrounded and influenced by its environment, is described by its boundaries, structure and purpose and expressed in its functioning.

As used herein, “method” refers to a particular procedure for accomplishing or approaching something. Accordingly, and with reference to this invention, when a particular set of rules is selected, the system can provide a method for automatically detecting and quantifying bacterial cells.

“Dosimetry” refers to the science by which radiation dose is determined by measurement, calculation, or a combination of measurement and calculation. The technical name for radiation dose is “absorbed dose”; it is the amount of radiation energy that is deposited in tissue divided by the mass of the tissue. This applies both internally, due to ingested or inhaled radioactive substances, or externally due to irradiation by sources of radiation.

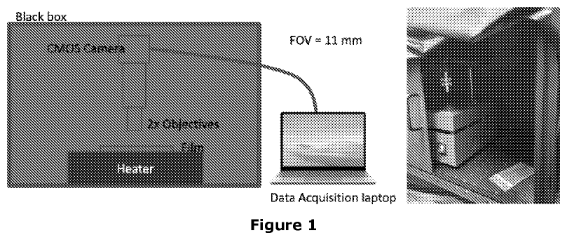

As shown in FIG. 1, the presently disclosed system comprises a radioluminescent film placed within an imaging chamber for dose readout of the radioluminescent film. The radioluminescent film may be optimised depending on the requirement. The radioluminescent film may be placed within the imaging chamber in order to evaluate the dosimetry property of the radioluminescent film.

The radioluminescent film may be configured to produce radio-luminescence when bombarded with ionizing radiation such as alpha particles, beta particles, or gamma rays. For example, the radio-luminescence may be electromagnetic radiation within the visible light range. In general, radio-luminescence occurs when an incoming particle of ionizing radiation collides with an atom or molecule, exciting an orbital electron to a higher energy level. The electron then returns to its ground energy level by emitting the extra energy as a photon of light. In particular, the ionizing radiation may be X-ray, Gamma ray, proton and other heavy ion particles for particle therapy.

The radioluminescent film may comprise a plurality of scintillator crystals that are capable of generating ionizing radiation-excited emissions. The emissions may be electromagnetic radiation within the visible light range. Scintillators are materials that are able to convert high energy radiation such as X or gamma-rays to a near visible or visible light. Accordingly, “scintillator crystal” refers to a scintillator which is also a crystalline particle with at least one dimension measuring less than 1000 μm. In particular, the crystal may be a micro-sized crystal and/or a nano-sized crystal. For example, the crystal may be a micro-sized crystal about 1 μm to about 900 μm, about 1 μm to about 850 μm, about 1 μm to about 800 μm, about 1 μm to about 750 μm, about 1 μm to about 700 μm, about 1 μm to about 650 μm, about 1 μm to about 600 μm, about 1 μm to about 550 μm, about 1 μm to about 500 μm, about 1 μm to about 450 μm, about 1 μm to about 400 μm, about 1 μm to about 350 μm, about 1 μm to about 300 μm, about 1 μm to about 250 μm, about 1 μm to about 200 μm, about 1 μm to about 150 μm, about 1 μm to about 100 μm, about 1 μm to about 80 μm, about 1 μm to about 60 μm, or about 1 μm to about 50 μm. The crystal may be a nano-sized crystal about 10 nm to about 900 nm, about 10 nm to about 850 nm, about 10 nm to about 800 nm, about 10 nm to about 750 nm, about 10 nm to about 700 nm, about 10 nm to about 650 nm, about 10 nm to about 600 nm, about 10 nm to about 550 nm, about 10 nm to about 500 nm, about 10 nm to about 450 nm, about 10 nm to about 400 nm, about 10 nm to about 350 nm, about 10 nm to about 300 nm, about 10 nm to about 250 nm, about 10 nm to about 200 nm, about 10 nm to about 150 nm, about 10 nm to about 100 nm, about 10 nm to about 80 nm, about 10 nm to about 60 nm, or about 10 nm to about 50 nm. A combination of micro-sized crystal and nano-sized crystal may also be used.

The plurality of scintillator crystals may be homogenously dispersed on a surface of the polymer layer or within the polymer layer. This allows for a consistent and high accuracy readout.

The radioluminescent film may comprise scintillator crystals selected from perovskite-based quantum dots, rare earth metal based scintillator, or a combination thereof.

The scintillator crystal may be perovskite-based quantum dots. The perovskite-based quantum dots may each have a formula of CsPbXₐY₃₋ₐ, CH₃NH₃PbX₃, or NH₂CH═NH₂PbX₃, in which each of X and Y, independently, is Cl, Br, or I, and a is 0-3. In some embodiments, the perovskite-based quantum dots is CsPbXₐY₃₋ₐ. Examples of the perovskite-based quantum dots include, but are not limited to, CsPbCl₃, CsPbCl₂Br, CsPbCl_{1.5}Br_{1.5}, CsPbClBr₂, CsPbCl_{2.5}Br_{0.5}, CsPbBr₃, CsPbBr₂I, CsPbBr_{1.8}I_{1.2}, CsPbBr_{1.5}I_{1.5}, CsPbBr_{1.2}I_{1.8}, CsPbBrI₂, and CsPbI₃.

The scintillator crystal may be a rare earth metal based scintillator. The rare-earth elements (REE), also called the rare-earth metals, are a set of 17 nearly-indistinguishable lustrous silvery-white soft heavy metals. Scandium and yttrium are considered rare-earth elements because they tend to occur in the same ore deposits as the lanthanides and exhibit similar chemical properties, but have different electronic and magnetic properties. These metals tarnish slowly in air at room temperature and react slowly with cold water to form hydroxides, liberating hydrogen. They react with steam to form oxides, and at elevated temperature (400 °C) ignite spontaneously. In some embodiments, the rare earth metal based scintillator is Na(Q_{b}R_{1-b})F₄. Q and R are different rare earth metals. The rare earth metals may be selected from Cerium, Dysprosium, Erbium, Europium, Gadolinium, Holmium, Lanthanum, Lutetium, Neodymium, Praseodymium, Promethium, Samarium, Scandium, Terbium, Thulium, Ytterbium, and Yttrium. b is a number which is more than 0 and less than 1; for example, 0.01≤b<1.

The radioluminescent film comprises a polymer layer. A polymer is a substance or material consisting of very large molecules called macromolecules, composed of many repeating subunits (monomers). For example, a fluoropolymer such as polytetrafluoroethylene, perfluoroalkoxy alkane, and ethylene tetrafluoroethylene may be used. Alternatively, a silicon-based polymer, such as polydimethylsiloxane (PDMS), may be used. For example, clear polymers like epoxy, polyurethane, polyethylene, polypropylene, acrylates, and polycarbonates may be used. Polymers which are used for radiotherapy phantom and bolus applications, such as polymethylmethacrylate (PMMA), polylactic acid (PLA), polystyrene, acrylonitrile butadiene styrene (ABS), vinyl may also be used. Fillers and additives like carbon, silica, or metallic powders can also be added to the polymer layer to modify the mechanical and absorption properties.

The polymer layer may be sufficiently clear to allow fluorescent light to escape. In this way, the sensitivity and/or accuracy of the system may be improved. The polymer layer may also have a water equivalence enough for radiotherapy purpose. For example, the polymer layer may be between about −100 HU (Hounsfield Units) to about 200 HU.

In some embodiments, the radioluminescent film comprises a plurality of scintillator crystals dispersed on a surface of the polymer layer. In some embodiments, the radioluminescent film comprises a plurality of perovskite-based quantum dots dispersed on a surface of the polymer layer. In this regard, the perovskite-based quantum dots are coated on a surface of the polymer layer. In some embodiments, the radioluminescent film comprises a plurality of scintillator crystals dispersed within the polymer layer. In some embodiments, the radioluminescent film comprises a plurality of perovskite-based quantum dots dispersed within the polymer layer. In some embodiments, the perovskite-based quantum dots is homogenously dispersed within the polymer layer.

In some embodiments, the radioluminescent film is characterised by a thickness of about 1 mm to about 10 mm. In other embodiments, the thickness is about 1 mm to about 9 mm, about 1 mm to about 8 mm, about 1 mm to about 7 mm, about 1 mm to about 6 mm, about 1 mm to about 5 mm, about 1 mm to about 4 mm, about 1 mm to about 3 mm, or about 1 mm to about 2 mm.

In some embodiments, the plurality of scintillator crystals is about 1% w/w to about 30% w/w relative to the polymer layer. In other embodiments, the weight ratio is about 1% w/w to about 25% w/w, about 1% w/w to about 20% w/w, about 3% w/w to about 20% w/w, about 3% w/w to about 18% w/w, about 3% w/w to about 16% w/w, about 3% w/w to about 14% w/w, about 3% w/w to about 12% w/w, about 3% w/w to about 10% w/w, or about 5% w/w to about 10% w/w.

In some embodiments, the radioluminescent film comprises a plurality of scintillator crystals dispersed within the polymer layer. In some embodiments, the radioluminescent film comprises a plurality of scintillator crystals dispersed within PDMS. In some embodiments, the radioluminescent film comprises a plurality of perovskite-based quantum dots dispersed within PDMS.

In some embodiments, the plurality of scintillator crystals dispersed on a surface of the polymer layer or within the polymer layer at a density of about 10 crystals/mm² to about 10,000 crystals/mm². In other embodiments, the density is about 100 crystals/mm² to about 10,000 crystals/mm², about 200 crystals/mm² to about 10,000 crystals/mm², about 300 crystals/mm² to about 10,000 crystals/mm², about 400 crystals/mm² to about 10,000 crystals/mm², about 500 crystals/mm² to about 10,000 crystals/mm², about 1000 crystals/mm² to about 10,000 crystals/mm², about 2000 crystals/mm² to about 10,000 crystals/mm², about 3000 crystals/mm² to about 10,000 crystals/mm², about 4000 crystals/mm² to about 10,000 crystals/mm², or about 5000 crystals/mm² to about 10,000 crystals/mm².

In some embodiments, the emission wavelength of the radioluminescent film is about 400 nm to about 600 nm. In some embodiments, the emission wavelength is about 400 nm to about 550 nm, or about 450 nm to about 550 nm.

The radioluminescent film may be excited by X-rays, in particular megavoltage X-rays. Megavoltage X-rays are produced by linear accelerators operating at voltages in excess of 1000 kV (1 MV) range, and therefore have an energy in the MeV range. The voltage refers to the voltage used to accelerate electrons in the linear accelerator and indicates the maximum possible energy of the photons which are subsequently produced. They are used in medicine in external beam radiotherapy to treat neoplasms, cancer and tumors. Megavoltage x-rays are preferred for treatment of deep lying tumours as they are attenuated less than lower energy photons, and will penetrate further, with a lower skin dose. Megavoltage x-rays also have lower relative biological effectiveness than orthovoltage x-rays.

The radioluminescent film exhibited a linear response to X-ray dose rate. It may detect X-ray photons at a low dose rate of 13 nGyₐᵢᵣ s⁻¹, which was 420 times lower than the dose threshold of medical radiation typically required for X-ray diagnostics (5.5 μGy_{air S}⁻¹). This radioluminescent film also exhibited a short scintillation decay time (ti) of 44.6 ns upon excitation with pulsed photons (661 keV) generated by a portable ¹³⁷Cs source, indicating a very fast response to X-rays photons and minimal afterglow luminescence. This short scintillation decay time of the radioluminescent film compares favorably to those of commercial bulk scintillators CsITi, PbWO₄, YAlO₃:Ce, and Bi₄Ge₃O₁₂, which exhibit scintillation decay times ranging from 300 ns to 10,000 ns.

In some embodiments, the radioluminescent film is characterised by a scintillation decay time of less than about 50 ns.

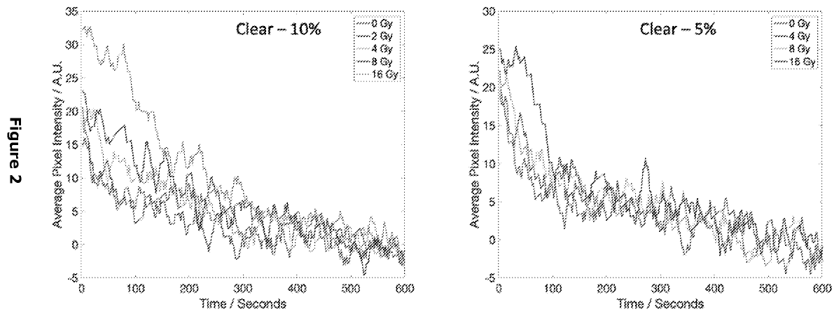

FIG. 2 shows plots of the luminescence intensity against time post-irradiation of radioluminescent films with 5% and 10% doping.

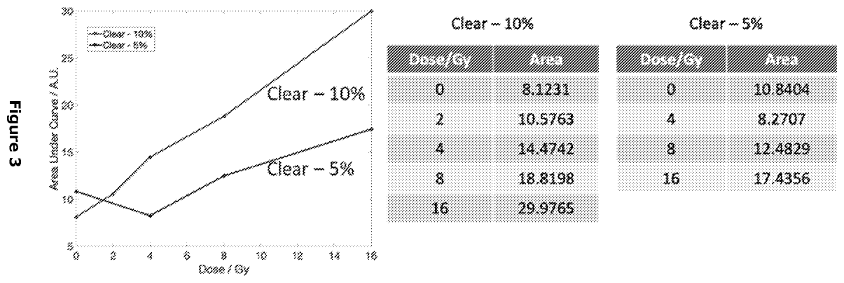

It is known from physics that luminescence intensity will be lower for megavoltage than kilovoltage x-rays due to smaller interaction cross section. Advantageously, the radioluminescent film fluoresce after irradiation with megavoltage X-ray beam. The fluorescence intensity was found to be linearly proportional to the X-ray dose with no sign of saturation up to 16 Gy (FIG. 3).

After the radioluminescent film is irradiated by ionizing radiation such as X-ray, the radioluminescent film is able to exhibit persistent radio-luminescence. Persistent luminescence is a phenomenon that is caused by slow liberation of radiation-induced trapped charged carriers. After the excitation source is removed, luminescence is emitted when the irradiation energy stored in intrinsic traps is released via electrons recombination with corresponding holes. In this regard, the excited scintillator crystal in the radioluminescent film (due to the radiation) emits electromagnetic radiation of a specific frequency and wavelength (and preferably in the visible light range), which can be detected, quantified and/or captured by the imaging chamber.

Accordingly, in some embodiments, the radioluminescent film is configured to exhibit persistent radio-luminescence upon excitation by an ionizing radiation. In some embodiments, the radioluminescent film is configured to exhibit persistent radio-luminescence after excitation by an ionizing radiation. The radio-luminescence may persist for at least 10 min, 20 min, 30 min, 40 min, 50 min or 60 min.

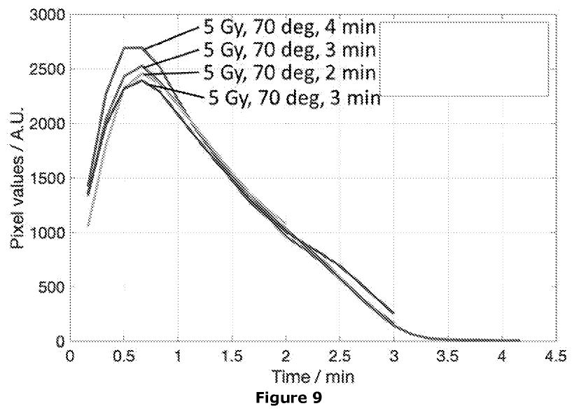

Heating the radioluminescent film may cause an increment of trapped electrons to be released and recombined with the holes. Consequently, this may improve the luminescence of the film, thus allowing for improved imaging and quantification. This is shown in FIG. 9. Heating the radioluminescent film causes the radio-luminescence to persist for at least 3 min, and less than about 5 min. While the radioluminescence may persist for a shorter amount of time, this is sufficient for imaging and quantification in the imaging chamber.

In some embodiments, the radioluminescent film is re-usable. In this regard, once the radioluminescent film has substantially lose its persistent radio-luminescence, it can be re-used. In other embodiments, the radioluminescent flim is re-usable for at least 5 cycles, or at least 10 cycles.

In some embodiments, the radioluminescent film is characterised by a 2D dose resolution of less than 2 mm.

If the ionizing radiation is strong enough, the radio-luminescence emitted from the radioluminescent film may be seen by the naked eye. For example, the radioluminescence may be increased by heating the radioluminescent film. If a lower dose of ionizing radiation is used, or if it is desirable to quantify the radio-luminescence, the radioluminescent film may be positioned within an imaging chamber and imaged for a longer duration in order to detect and/or quantify the radio-luminescence emitted from the radioluminescent film. In this regard, a low ionizing radiation may be used and still be detectable by the radioluminescent system.

For example, the radioluminescent film may exhibit radio-luminescence when excited by an ionising radiation of about 0.1 Gy. The radioluminescent film may exhibit radio-luminescence when excited by an ionising radiation of up to about 20 Gy. In some embodiments, the radioluminescent film is excitable by an ionising radiation of at least about 0.1 Gy, or from about 0.1 Gy to about 20 Gy. In some embodiments, the radioluminescent film is excitable by an ionising radiation of at least about 0.5 Gy, or from about 0.5 Gy to about 20 Gy.

In some embodiments, the radioluminescent film is characterised by a resolution of about 0.03 mm/pixel to about 0.1 mm/pixel. In other embodiments, the resolution is about 0.03 mm/pixel to about 0.09 mm/pixel, about 0.03 mm/pixel to about 0.08 mm/pixel, about 0.03 mm/pixel to about 0.07 mm/pixel, about 0.03 mm/pixel to about 0.06 mm/pixel, or about 0.03 mm/pixel to about 0.05 mm/pixel. In some embodiments, the radioluminescent film is characterised by a resolution of about 0.04 mm/pixel.

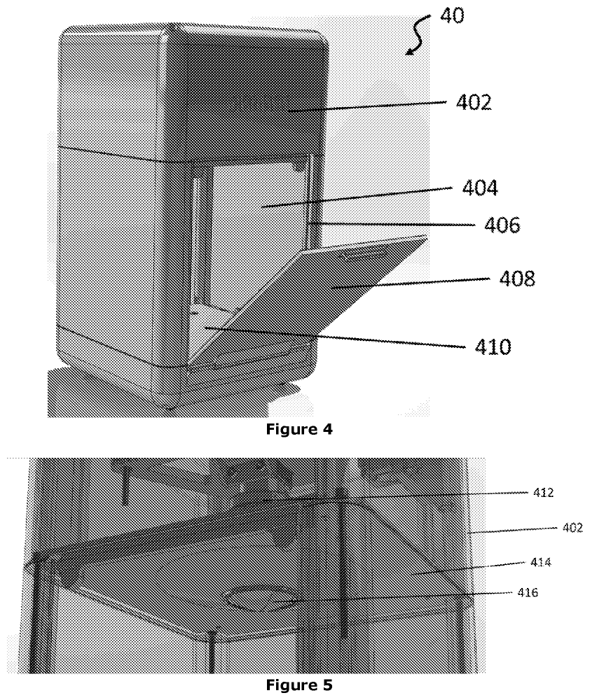

FIG. 4 shows an embodiments of the imaging chamber 40. The imaging chamber 40 may comprise a black box 404. The black box 404 blocks away ambient light to increase the signal to noise ratio of the camera in detecting the light output from the film. It can be made of black hardboard or black aluminium/metal material. The black box 404 may have an opening 406 such that the interior of the black box may be accessed. When the opening 406 is closed, the black box 404 blocks out light and minimises light contamination during the dose readout to ensure minimal noise for accurate low dose measurement down to 0.1 Gy. The opening 406 may comprise a cover 408 in order to close the opening. The cover 408 may be a slidable cover. The slidable cover may be advantageous as it can be fabricated to be at least slightly larger than the opening and thus can block out light that may enter the interior from the edges of the opening. Alternatively, the cover 408 may be a door or a hatch. The black box 404 may further comprise blackout curtains to further reduce light contamination. For example, the blackout curtain may be suitably positioned adjacent to the opening 406 such that light from the edges of the opening can be blocked from entering the interior of the box. The blackout curtain may be positioned internally within the black box 404 or externally of the black box 404.

The imaging chamber 40 may comprise an instrument chamber 402. The instrument chamber 402 may comprise a photodetector 412. A photodetector is an optoelectronic device that converts incident light or other electromagnetic radiation in the UV, visible, and infrared spectral regions into electrical signals. In this way, by scanning the radioluminescent film and quantifying the intensity of the radio-luminescence, a dosing map can be obtained. The photodetector may be a photomultiplier tube (PMT) detector, a thin-film transistor (TFT) photodiode sensor, a charge-coupled device (CCD) sensor, a complementary metal-oxide-semiconductor (CMOS) sensor, or an indium gallium zinc oxide (IGZO) TFT sensor. sCMOS or EMCCD may be used.

The instrument chamber 402 may comprise a digital camera. The camera offers 2D information of the radioluminescent film. For example, the imaging chamber may comprise charged-coupled device (CCD) camera or complementary metal oxide semiconductor (CMOS) camera. A CCD is a light-sensitive integrated circuit that captures images by converting photons to electrons. A CMOS sensor is an electronic chip that converts photons to electrons for digital processing. The camera may further comprise lenses. These optical components are configured to achieve field of view (FOV) of at least 10 cm to cover most treatment field sizes commonly encountered in the clinic. The camera may capture an image of the illuminated radioluminescent film. It was found that this setup can achieve sub-millimeter pixel resolution which is comparable to Gafchromic film dosimetry.

In some embodiments, the imaging chamber may comprise both a photodetector and a camera.

The instrument chamber 402 may be separated from the black box 404 by a separator 414. The separator 414 may be a metal plate. The separator 414 serves to prevent easy access to the instruments, thus protecting the instruments. The separator may comprise at least one orifice, from which a portion of the photodetector and/or camera passes through. This allows for imaging of the radioluminescent film in the black box 404. The portion of the photodetector and/or camera may be covered by a shutter 416, configured to open when the photodetector and/or camera is in use and close when not in use.

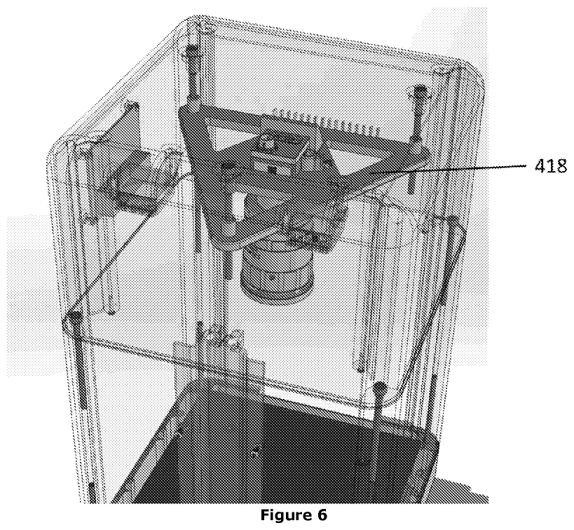

FIG. 6 shows a perspective view of the instrument chamber 402. The camera and/or photodetector may be adjusted so that the substantially the whole base of the black box 404 may be captured. The camera and/or photodetector may be adjusted by means of a displacement means 418. The displacement means 418 may allow adjustment along any axis of the Cartesian axis, and further allow for tilting of the camera and/or photodetector along a longitudinal axis of the imaging chamber.

The distance of the radioluminescent film to the camera and/or photodetector may be adjustable. This depends on the focal length of the imaging chamber. Additionally, it was found that a distance of at least 3 cm from the radioluminescent film (and heater plate) to the photodetector and/or camera may facilitate space for removing and placing the radioluminescent film easily within the imaging system, and for slowing heat conduction to the photodetector and/or camera which can increase the noise in the photodetector and/or camera.

In some embodiments, the camera and/or photodetector is characterised by a frame integration time of at least about 1 s, about 2 s, about 3 s, about 4 s, about 5 s, about 6 s, about 7 s, about 8 s, about 9 s, about 10 s, about 11 s, or about 12 s.

The imaging chamber may comprise a heating plate. The heating plate may be positioned within the black box. The heating plate may be configured to heat the radioluminescent film to a temperature of about 70 °C in order to excite the electrons in the radioluminescent film for fluorescence light production. This can provide better resolution if the radio-luminescence from the radioluminescent film is weak. The heating also accelerates the relaxation of the scintillator crystals, and accordingly, the radioluminescent film may be reused after a short recovery duration if required.

The time required for the radioluminescent film to substantially lose its persistent radio-luminescence may decrease with increasing temperature of the heater plate. The radioluminescent film may be configured to substantially lose its persistent radio-luminescence after about 5 min upon contact with heat of about 60 °C to about 70 °C from the heating plate. In some embodiments, at least about 70% of the persistent radio-luminescence is lost after about 5 min upon contact with heat from the heating plate.

The control system can be a computer implemented system. The control system may be operable to activate the components in the imaging chamber. This can involve a computer programme which regulates the activating of photodetector, camera and heating plate. The control system may comprise a software for controlling data and/or image acquisition. The control system may also be configured with data relating to the control (calibration plot).

The radioluminescent system can respond to radiation at very low dose rates. In some embodiments, the radioluminescent system can respond to radiation at a dose rate of less than about 50 nGy_{airS}⁻¹. In other embodiments, the dose rate is less than about 40 nGy_{airS}⁻¹, about 30 nGy_{airS}⁻¹, about 20 nGy_{airS}⁻¹, about 15 nGy_{airS}⁻¹, about 10 nGy_{airS}⁻¹, or about 8 nGy_{airS}⁻¹.

In some embodiments, the radioluminescent system is characterised by a minimum dose limit of about 0.2 Gy.

In some embodiments, the radioluminescent system is characterised by a dose saturation of about 16 Gy.

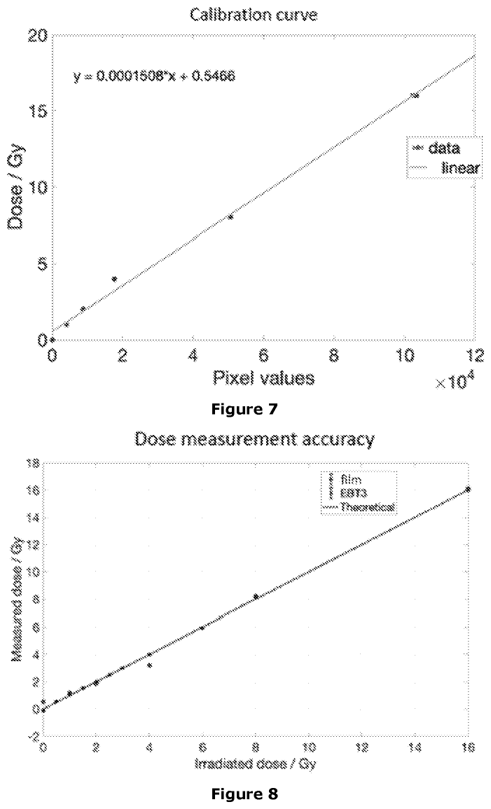

FIG. 7 shows a plot of dose against pixel values. With increasing dose, the pixel value increases proportionally. The system is usable at a dose of at least about 0.2 Gy.

FIG. 8 shows a plot of dose measurement accuracy. The system is was found to accurately output a measured dose relative to the irradiated dose. In contrast, some variations were observed for Gafchromic film.

In some embodiments, the radioluminescent system is configured to quantify and/or spatially map the persistent radio-luminescence of the radioluminescent film in less than about 10 min. In this regard, the photodetector and/or camera may have a shutter speed of less than about 10 min in order to integrate all the scintillation signal. In other embodiments, the time is less than about 9 min, about 8 min, about 7 min, about 6 min, about 5 min, about 4 min, about 3 min, about 2 min, or about 1 min.

FIG. 9 shows plots of the luminescence intensity against time post-irradiation for samples irradiated with a radiation dose of 5 Gy for various durations. At a same dosage, with increasing radiation durations, the pixel value increases and thus resolution increases.

It was found that this radioluminescent system is simple to use in a clinical setting. For example, the radioluminescent film can be used to provide a 2D dose image of a patient's treatment region. The information can be obtained relatively quickly with the patient being dosed a lower radiation dose. If a tomographic image is required, several 2D radioluminescent films can be stacked on top of each other and irradiated on the patient's treatment region. As each radioluminescent film is stacked a specific distance away from the patient's treatment region, the focal plane is different. Each radioluminescent film may then be imaged separately in the imaging chamber and the images combined to form a 3D image.

The present invention also provides a method of performing pre-treatment patient-specific quality assurance (PSQA) by using the radioluminescent system as disclosed herein. In this regard, the radioluminescent film (such as a rare-earth metal-doped film) can be positioned against the patient's treatment region and irradiated with ionising radiation. The radioluminescent film may then be removed from the patient and positioned within the imaging chamber for high resolution dose mapping, image capturing and/or quantification. The radioluminescent film may be used.

### EXAMPLES

### Example 1: Radioluminescent Film Containing Perovskite-Based Quantum Dots

### Synthesis of Cs-Oleate as a Cesium Precursor for Preparing

In a typical procedure, to a two-neck round-bottomed flask (50 mL) were added Cs₂CO₃ (0.4 g; 1.23 mmol), oleic acid (OA; 1.25 mL) and octadecene (ODE; 15 mL). The resulting mixture was heated to 100 °C under vigorous stirring and vacuum condition for 0.5 h.

Afterwards, a nitrogen purge and vacuum were alternately applied to the flask for three times each to remove moisture and O₂. Subsequently, the reaction was heated to 150 °C and the solution became clear, indicating the completion of reaction between Cs₂CO₃ and OA. The Cs— solution was kept at 150 °C under a nitrogen atmosphere prior to perovskite nanocrystal synthesis.

### Synthesis and Characterization of Perovskite-Based Quantum Dots

CsPbX₃ perovskite quantum dots can be synthesized following the hot-injection method below.

PbX₂ (0.36 mmol; X=Cl, Br, or I), oleic acid (1.0 mL), oleylamine (1.0 mL), and ODE (10 mL) were added to a two-neck round bottom flask (50 mL). The resulting mixture was heated to 100 °C with vigorous stirring and under vacuum for 0.5 h, during which moisture was removed by purging with nitrogen and vacuum suction. The mixture was then heated to 160 °C until the PbX₂ completely dissolved. A hot Cs-oleate solution (1.0 mL) was quickly injected into the reaction mixture. After 5 s of reaction, the flask was transferred into an ice bath. CsPbX₃ quantum dots were obtained by centrifugation at 13000 rpm for 10 min and stored in 4 mL of cyclohexane prior to further use.

Twelve samples having different halide compositions were prepared, i.e., CsPbCl₃ (sample 1), CsPbCl₂Br (sample 2), CsPbCl_{1.5}Br_{1.5} (sample 3), CsPbClBr₂ (sample 4), CsPbCl_{2.5}Br_{0.5} (sample 5), CsPbBr₃ (sample 6), CsPbBr₂I (sample 7), CsPbBr_{1.8}I_{1.2} (sample 8), CsPbBr_{1.5}I_{1.5} (sample 9), CsPbBr_{1.2}I_{1.8} (sample 10), CsPbBrI₂ (sample 11), and CsPbI₃ (sample 12). The samples containing mixed-halides were readily obtained by using appropriate ratios of different PbX₂ salts.

The nanocrystals were characterized by TEM imaging using a LEI Tecnai G20 transmission electron microscope with an accelerating voltage of 200 kV and by powder X-ray diffraction using an ADDS wide-angle X-ray powder diffractometer with CuKₐ radiation (λ=1.54184 A). An exemplary TEM image reveals a cubic shape of the as-synthesized quantum dots, which have an average size of 9.6 nm.

A study was conducted to investigate the possibility of using the perovskite quantum dots for multicolored X-ray scintillation. More specifically, radioluminescence of solid nanocrystal films (10 mm) formed from samples 1-12 was measured using an Edinburgh LS5 fluorescence spectrophotometer (Edinburgh Instruments Ltd., UK) equipped with a miniature X-ray source (AMPEK, Inc.). Four commercial bulk scintillators, i.e., CsI:Tl, PbWO₄, YAlO₃:Ce, and Bi₄Ge₃O₁₂ were included for comparison. As shown in Table 1, the nanocrystal films exhibited emission peaks with small full-width-half-maximum (FWHM) values ranging from 12 nm to 40 nm and emission maxima ranging from 410 nm to 700 nm. In contrast, radioluminescence of the four conventional bulk scintillators was invariable, and exhibited a wide emission peaks with a large value of full-width-at-half-maximum (FWHM) (Table 1). Further, sensitivity of a CsPbBr₃ nanocrystal thin film to X-ray illumination was compared to that of the four commercial bulk scintillators. It was found that, at a low-irradiation dose of 5.0 μGy_{airS}⁻¹ (10 kV, 5 μA), the ability of the CsPbBr₃ nanocrystal thin film (thickness: ~0.l mm) to convert X-ray photons into visible luminescence was comparable to that of CsI:Tl and far superior to that of PbWO₄, YAlO₃:Ce, and Bi₄Ge₃O₁₂ (Table 1). This superior performance of the CsPbBr₃ nanocrystals was attributed to large X-ray stopping power and high emission quantum yields of the Pb-halide quantum dots.

These results indicate that the perovskite-based quantum dots described herein are particularly suitable for achieving high-efficiency, multicolored X-ray scintillation.

TABLE 1
Scintillation characteristics for different types of materials

| | Emission | | | Emission | Decay |
|---|---|---|---|---|---|
| | Maximum | FWHM | Thickness | Intensity | Time |
| Material | (nm) | (nm) | (mm) | (au) | (ns) |
| CsPbX₃ | 410-700 | 12-40 | 0.1 | 100 | 44.6 |
| (QDs) | | | | | |
| CsI:Tl | 565 | 155 | 5.0 | 185 | 1000 [symbol] |
| (bulk) | | | | | |
| Bi₄Ge₃O₁₂ | 490 | 160 | 3.0 | 7.0 | 300 ^{a} |
| (bulk) | | | | | |
| YAlO₃:Ce | 380 | 55 | 0.6 | 19.4 | 10²-10 [symbol] ^{a} |
| (bulk) | | | | | |
| PbWO₄ | 440 | 120 | 5.0 | 0.35 | 10²-10⁴ [symbol] |
| (bulk) | | | | | |

^{a} See Niki, M., Meas. Sci. Technol., 2016, 17, 37-54. [symbol]
indicates data missing or illegible when filed

### Fabrication of Radioluminescent Film Containing Perovskite-Based Quantum Dots

Flexible nanocrystal scintillators were prepared by a combination of solution processing and a standard soft lithography microfabrication technique. Briefly, a photomask was first designed using Adobe Illustrator CS6. A negative photoresist having a thickness of 60 μm was then spin-coated (SU-8 2015, 2500 rpm, 60 s) onto a silicon wafer (3 in.), which was prebaked at 60 °C for 10 min and then 85 °C for 5 min.

Subsequently, the silicon wafer was placed under a UV lamp for 20 s and subjected to post baking treatment in an oven at 75 °C for 5 min. Next, the desired microstructure on the silicon wafer was produced using a developer solution. A PDMS substrate was fabricated on the silicon wafer with a premixed PDMS prepolymer and curing agent (10:1 by mass) under vacuum condition, subjected to heat treatment at 80 °C for 2 h, then carefully peeled off the silicon wafer. Finally, a dispersion of perovskite quantum dots in cyclohexane was spin-coated onto the PDMS substrate to form a thin film, thereby obtaining a nanocrystal scintillator.

### Fabrication of Radioluminescent Film Containing Rare-Earth Metal Based Scintillator.

0.3M (0.5 mL) Sodium acetate was mixed with 0.2M rare earth chlorides (2 mL; 85% YCl₃, 15% TbCl₃) in a beaker. 0.5M NaF (9.6 mL) was then added slowly with vigorous stirring. After stirring for 15 minutes, the solution was transferred to an autoclave and heated in an oven at 200 °C for 12 hours. After cooling to room temperature, the scintillator crystals were isolated by centrifugation, washed twice with ethanol and then dispersed in toluene. The scintillator crystal dispersion was then mixed into PDMS prepolymer. The solvents were removed under vacuum before the curing agent (prepolymer to curing agent=10:1 by mass) was mixed in and the mixture was cured at 80 °C for 2 hours to obtain the radioluminescent film.

### Example 2: X-Ray Phase Contrast Imaging Using a Radioluminescent Film

A study was conducted to assess the suitability of radioluminescent film for X-ray phase contrast imaging.

First, a green scarab beetle was implanted with a metallic needle. Subsequently, the beetle was placed between an X-ray source and a radioluminescent film, which included a thin film layer of CsPbBr₃ quantum dots coated on a plastic disk. X-ray images were then recorded at a voltage of 50 kV. Note that the CsPbBr₃ nanocrystals were chosen because their green emission at 530 nm matched well with the maximum wavelength response of a CMOS sensor.

Due to a large difference in X-ray stopping power, the needle inside the beetle was clearly revealed in a phase contrast image, which was conveniently recorded with a conventional digital camera.

The results demonstrate that radioluminescent film can be readily used for direct X-ray contrast imaging.

### Example 3: Radioluminescent System

The design of the optical imaging system prototype used in this experiment is shown in FIG. 1. The film is first irradiated with a TrueBeam linear accelerator (Linac) using a 20 cm square field 6MVp X-ray beam. Four different doses (2, 4, 8 and 16 Gy) were delivered to the film and the film is placed at the heater plate right after each irradiation for the light output to be completely measured by the camera. The heater was set at 70 °C and the camera image was integrated over 5 minutes to collect the total light output from the film over this period. The average pixel values over a 25 pixels squares region in the image were calculated and plotted against the dose. The dose of the Linac was calibrated monthly using the TRS 398 protocol and is accurate to within 1.5%.

Measurement with the flexible radioluminescent film verifies that the film exhibit sufficient radio-luminescence post-irradiation with megavoltage X-ray. The results are shown in FIG. 1 to FIG. 3. In conclusion, the results show unambiguously that the radioluminescent film exhibit persistent radio-luminescence with megavoltage x-rays.

The dosimetric properties of the radioluminescent system are measured and benchmarked relative to other commercial products such as Gafchromic film. The system is also compared to other 2D diode/ion chambers such as SNC MapCheck and PTW Octavius.

### Minimum Dose Limit

The minimum dose that can be measured was determined based on the plot of pixel values against irradiation dose. The background noise of the camera was measured. The dose corresponding to the pixel value of the background noise is the minimum dose limit.

### Dose Sensitivity

The increase in pixel intensity for each unit of dose increase was measured based on the plot of pixel values against irradiation dose. The gradient of this plot provides information on the dose sensitivity.

### Dose Linearity

The linearity of pixel intensity as a function of different doses was measured based on the plot of pixel values against irradiation dose. The linearity of this plot provides information on the dose linearity.

### Dose Saturation

The maximum dose that can be measured by the setup without saturating the pixel intensity was determined based on the plot of pixel values against irradiation dose. The plot provides information on the saturation dose, which could be limited by camera dynamic range or film's output.

### Reproducibility

The dose reproducibility from the setup across different days and different batches of films was determined based on the standard deviation of the dose measurement using the film over several days.

### Radiation Damage

The effect of repeated use of high dose irradiation on the film was tested based on a plot of the decrease in light output against the irradiation dose over extended usage.

### Example 4

The radioluminescent film was tested in the imaging chamber. Temperature was set to 70 °C, and the starting temperature of plate is ~50 °C. Total measurement time is 3 minutes. Integration time is 10 seconds. 5 pixels median filtering was applied. A second dose read-out is performed after each initial dose read-out to confirm the film is free of traps and register 0 Gy before another round of irradiation. A uniform dose was irradiated on the film with 6 MV and 10 cm field size. The dose and pixel values were obtained around the central region of the film.

The film can be observed to light up at 0.5 Gy (FIG. 7). 3 minutes dose readout is sufficient to integrate all the scintillation signal. The time may be further reduced. Dose-signal linearity is observed up to 16 Gy. The pixel value varies linearly with respect to dose. Current pixel resolution is 0.043 mm/pixel. This can be relaxed to 0.1 mm/pixel by binning of pixels. If performed at CMOS hardware level, this can increase the SNR and improve the low dose sensitivity. The noise may be lowered by increasing NP homogeneity, improving thickness homogeneity of the film and low noise CCD or CMOS camera.

Compared with EBT3 Gafchromic film, the radioluminescent film has good dose measurement accuracy and may be used to a higher irradiated dose (FIG. 8).

### Example 5

Radioluminescent films of various scintillating crystals and concentration were fabricated. For example, the film may be NaF in PDMS. The scintillations are clearly visible at 8 Gy irradiation. It was found that a homogenous dispersion of scintillating crystals and with no or minimal conglomerates may give a good dose uniformity with flatness not exceeding 3% and dose sensitivity. Alternatively, or concurrently, a maximum frame integration time of 10 s or more may be used, optionally with a lower noise camera.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Throughout this specification and the claims which follow, unless the context requires otherwise, the phrase “consisting essentially of”, and variations such as “consists essentially of” will be understood to indicate that the recited element(s) is/are essential i.e. necessary elements of the invention. The phrase allows for the presence of other non-recited elements which do not materially affect the characteristics of the invention but excludes additional unspecified elements which would affect the basic and novel characteristics of the method defined.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A radioluminescent system, comprising:
a) an imaging chamber comprising a camera and/or photodetector housed within the imaging chamber; and
b) a control system operable to activate the camera and/or photodetector;
wherein a radioluminescent film configured to exhibit persistent radio-luminescence upon excitation by an ionizing radiation is positionable within the imaging chamber for quantifying and/or spatially mapping the persistent radio-luminescence of the radioluminescent film by the camera and/or photodetector;
wherein the radioluminescent film comprises a plurality of scintillator crystals dispersed on a surface of a polymer layer or within the polymer layer.

2. The radioluminescent system according to claim 1, wherein the plurality of scintillator crystals is a plurality of perovskite-based quantum dots or rare earth metal based scintillators.

3. The radioluminescent system according to claim 2, wherein the perovskite-based quantum dots is CsPbXₐY₃₋ₐ or the rare metal based scintillator is Na(Q_{b}R_{1-b})F₄;
wherein X and Y are independently selected from Cl, Br, and I;
a is a number selected from 0 to 3;
Q and R are independently rare earth metals; and
b is a number which is more than 0 and less than 1.

4. The radioluminescent system according to claim 1, wherein the plurality of scintillator crystals is about 1% w/w to about 30% w/w relative to the polymer layer.

5. The radioluminescent system according to claim 1, wherein the polymer layer is flexible.

6. The radioluminescent system according to claim 1, wherein the polymer is polydimethylsiloxane.

7. The radioluminescent system according to claim 1, wherein the radioluminescent film is excitable by an ionising radiation of up to about 20 Gy.

8. The radioluminescent system according to claim 1, wherein the radioluminescent film is characterised by a resolution of about 0.03 mm/pixel to about 0.1 mm/pixel.

9. The radioluminescent system according to claim 1, wherein the camera and/or photodetector is adjustable via a displacement means, the displacement means configured to allow movement along any axis of the Cartesian axis and tilting along a longitudinal axis of the imaging chamber.

10. The radioluminescent system according to claim 1, wherein the imaging chamber further comprises a heating plate.

11. The radioluminescent system according to claim 1, wherein the radioluminescent film is configured to lose its persistent radio-luminescence after about 5 min upon contact with heat from a heating plate.

12. The radioluminescent system according to claim 1, wherein the radioluminescent film is re-usable for at least 10 cycles.

13. The radioluminescent system according to claim 1, wherein the radioluminescent film is characterised by a 2D dose resolution of less than 2 mm.

14. The radioluminescent system according to claim 1, wherein the radioluminescent system is responsive to a radiation dose rate of less than about 50 nGy_{airS}⁻¹.

15. The radioluminescent system according to claim 1, wherein the radioluminescent system is configured to quantify and/or spatially map the persistent radio-luminescence of the radioluminescent film in less than about 10 min.

16. A method of performing pre-treatment patient-specific quality assurance (PSQA) by using the radioluminescent system according to claim 1.
